(19) United States
(12) Patent Application Publication
(10) Pub. No.: US 2018/0371296 A1
(43) Pub. Date: Dec. 27, 2018

(54) A Sealant, a Liquid Crystal Display Panel and its Preparation Method

(71) Applicants: BOE Technology Group Co., Ltd., Beijing (CN); Beijing BOE Optoelectronics Technology Co., Ltd., Beijing (CN)

(72) Inventors: Xiaojuan Wu, Beijing (CN); Kaixuan Wang, Beijing (CN); Wei Li, Beijing (CN); Hongliang Yuan, Beijing (CN); Yang You, Beijing (CN); Zijing Zhang, Beijing (CN); Qi Zheng, Beijing (CN); Jialong Li, Beijing (CN)

(73) Assignees: BOE Technology Group Co., Ltd., Beijing (CN); Beijing BOE Optoelectronics Technology Co., Ltd., Beijing (CN)

(21) Appl. No.: 15/562,753

(22) PCT Filed: Apr. 1, 2017
(86) PCT No.: PCT/CN2017/079312

§ 371 Date: Sep. 28, 2017

(30) Foreign Application Priority Data
Aug. 17, 2016 (CN) 201610683011.3

(51) Int. Cl. C09J 11/06; G02F 1/1333

(52) U.S. Cl. CPC C09J 11/06; C09K 19/3444; G02F 1/1333

(57) ABSTRACT

Disclosed are a sealant, a liquid crystal display panel and its preparation method. The sealant includes a bulk and a component that induces orientation of a liquid crystal molecule and is mixed in the bulk. The sealant can induce orientation of liquid crystal molecules, and may prevent the liquid crystal molecules from being disturbed in orientation, thereby preventing light leakage of the liquid crystal display panel, even in the case where uncured small molecules in the sealant enter the liquid crystal layer.

### TECHNICAL FIELD

Embodiments of the present disclosure relate to a sealant, a liquid crystal display panel and its preparation method.

### BACKGROUND

A liquid crystal display panel generally includes an array substrate, an opposite substrate, and a liquid crystal layer disposed between the array substrate and the opposite substrate. A method for manufacturing a liquid crystal display panel generally includes: forming a sealant between an array substrate and an opposite substrate; and curing the sealant to bond the array substrate and the opposite substrate together and seal a liquid crystal layer between the array substrate and the opposite substrate. However, the sealant is difficult to reach a curing ratio of 100%.

When a liquid crystal display panel displays, the liquid crystal molecules 10 in a liquid crystal layer are regularly oriented in a specific direction, as shown in FIG. 1a. However, as described above, the sealant 20 is difficult to reach a curing ratio of 100%; in this case, small molecules 30 which are not cured and polymerized in the sealant 20 will enter the liquid crystal layer, causing the orientation of the liquid crystal molecules 10 in the liquid crystal layer, at least the liquid crystal molecules 10 close to the sealant 20, to be disturbed, as shown in FIG. 1b. In the case where the orientation of the liquid crystal molecules is disturbed, a light leakage phenomenon may happen to the liquid crystal display panel.

### SUMMARY

One aspect of the present disclosure provides a sealant comprising a bulk and a component that induces orientation of a liquid crystal molecule and is mixed in the bulk.

In one embodiment, the component that induces orientation of a liquid crystal molecule is isotropic under irradiation of ultraviolet light and is anisotropic under irradiation of visible light.

In one embodiment, the component that induces orientation of a liquid crystal molecule is a liquid crystal with a halogen bond of an azopyridine derivative.

In one embodiment, the halogen bond in the liquid crystal with a halogen bond of an azopyridine derivative is at least one of an iodine bond and a bromine bond.

In one embodiment, a group chemically bonded to the azopyridine group in the liquid crystal with a halogen bond of an azopyridine derivative comprises —O—CₙH₍₂ₙ₊₁₎.

In one embodiment, n in the —O—CₙH₍₂ₙ₊₁₎ group is in the range of 7 to 24.

In one embodiment, the liquid crystal with a halogen bond of an azopyridine derivative has a mass content of about 1 to 10% in the sealant.

In one embodiment, the bulk comprises an ultraviolet curable component.

In one embodiment, the bulk further comprises a thermally curable component.

Another aspect of the present disclosure provides a method of manufacturing a liquid crystal display panel, which comprises:

providing an array substrate, an opposite substrate, and a liquid crystal layer between the array substrate and the opposite substrate;
providing a sealant between the array substrate and the opposite substrate; and curing the sealant, so as to seal the liquid crystal layer between the array substrate and the opposite substrate; wherein the sealant comprises a bulk and a component that induces orientation of a liquid crystal molecule in the liquid crystal layer and is mixed in the bulk.

In one embodiment, curing the sealant comprises irradiating the sealant under ultraviolet light; and the liquid crystal with a halogen bond of an azopyridine derivative is converted to isotropic state upon irradiating the sealant under ultraviolet light.

In one embodiment, curing the sealant further comprises thermal curing of the sealant.

In one embodiment, the method for manufacturing a liquid crystal display panel further comprises: irradiating the sealant under visible light after curing the sealant, so as to convert the liquid crystal with a halogen bond of an azopyridine derivative to anisotropic state.

Yet another aspect of the present disclosure provides a liquid crystal display panel. The liquid crystal display panel includes an array substrate, an opposite substrate, and a liquid crystal layer between the array substrate and the opposite substrate. The liquid crystal display panel further includes the sealant as described above, which is located between the array substrate and the opposite substrate and seals the liquid crystal layer between the array substrate and the opposite substrate.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1a is a schematic view showing arrangement of liquid crystal molecules in the liquid crystal layer of the liquid crystal display panel;

FIG. 1b is a schematic view showing arrangement of liquid crystal molecules in the liquid crystal layer in the case where small molecules that are not cured and polymerized in the sealant enter the liquid crystal layer;

FIG. 2a shows the change in the state of a liquid crystal with a halogen bond of an azopyridine derivative in a smectic phase under irradiation of UV or visible light;

FIG. 2b shows the change in the state of a liquid crystal with a halogen bond of an azopyridine derivative in a nematic phase under irradiation of UV or visible light;

FIG. 3a is a flow chart of a method for manufacturing a liquid crystal display panel according to an embodiment of the present disclosure;

FIG. 3b is a schematic structural view of a liquid crystal display panel according to an embodiment of the present disclosure;

FIG. 4a is a schematic view showing arrangement of liquid crystal molecules in the case where small molecules that are not cured and polymerized in the sealant do not enter the liquid crystal layer according to an embodiment of the present disclosure; and

FIG. 4b is a schematic view showing arrangement of liquid crystal molecules in the case where small molecules that are not cured and polymerized in the sealant enter the liquid crystal layer according to an embodiment of the present disclosure.

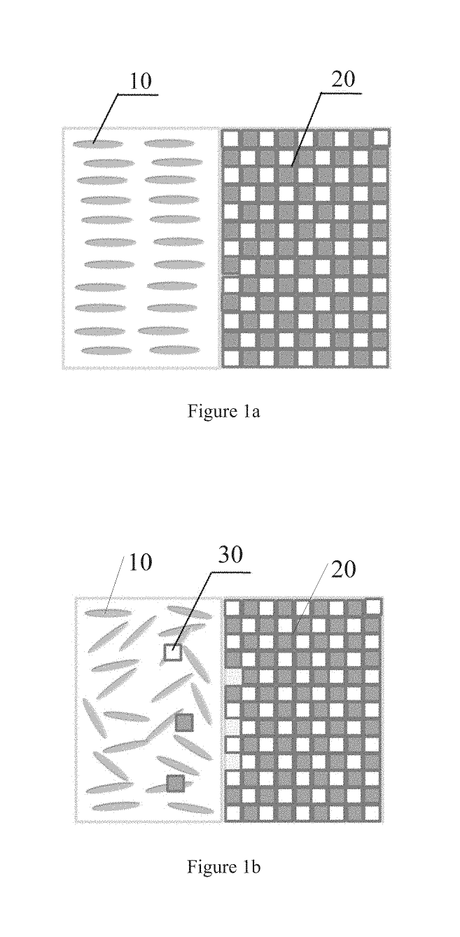

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Embodiments of the present disclosure provide a sealant comprising a bulk and a component that induces orientation of a liquid crystal molecule and is mixed in the bulk. The sealant can induce orientation of liquid crystal molecules, and may prevent the liquid crystal molecules from being disturbed in orientation, thereby preventing light leakage of the liquid crystal display panel, even in the case where uncured small molecules in the sealant enter the liquid crystal layer.

The principle that orientation of a liquid crystal molecule is induced by the component inducing orientation of a liquid crystal molecule, for example, can be that the component is regularly oriented in a specific direction by itself, thereby causing the liquid crystal molecules nearby to be also oriented in the specific direction.

For example, the component that induces orientation of a liquid crystal molecule can be uniformly dispersed in the bulk of the sealant, thereby increasing uniformity of the orientation of the liquid crystal molecules induced by the sealant.

In one embodiment, the component that induces orientation of a liquid crystal molecule is isotropic under irradiation of ultraviolet light and is anisotropic under irradiation of visible light. The bulk of the sealant typically comprises an ultraviolet curable component to cure the sealant under irradiation of ultraviolet light. In the case where the sealant is irradiated under ultraviolet light, the component that induces orientation of a liquid crystal molecule is, for example, isotropic so as to be better mixed with the bulk of the sealant to avoid reducing the viscosity of the sealant, and at the same time, avoid separating the component inducing orientation of a liquid crystal molecule from the bulk during the UV curing process and affecting the curing effect. In addition, the component that induces orientation of a liquid crystal molecule need to be able to induce orientation of the liquid crystal molecule. As described above, the component that induces orientation of a liquid crystal molecule is, for example, oriented in a specific direction by itself, thereby inducing the liquid crystal molecules to be also oriented in the specific direction. Thus, after UV curing of the sealant, the component that induces orientation of a liquid crystal molecule need to be oriented in a specific direction, i.e., need to be changed from isotropic state to anisotropic state. For example, the component that induces orientation of a liquid crystal molecule can be changed to anisotropic state under irradiation of visible light. By adding to the bulk of a sealant a component which is isotropic under irradiation of ultraviolet light and anisotropic under irradiation of visible light, on the one hand, the effect of the added component on the viscosity and curing effect of the sealant can be avoided without an additional process; on the other hand, the component can be conveniently converted into anisotropic state under irradiation of visible light, thereby effectively inducing orientation of the liquid crystal molecules.

For example, the component that induces orientation of a liquid crystal molecule is also isotropic before curing the sealant, so that the component that induces orientation of a liquid crystal molecule can be easily mixed in the bulk of the sealant when the sealant is prepared.

In one embodiment, the component that induces orientation of a liquid crystal molecule is a liquid crystal with a halogen bond of an azopyridine derivative. Under irradiation of ultraviolet light, the azo group in the liquid crystal with a halogen bond of an azopyridine derivative is transformed from a trans structure to a cis structure, which makes the liquid crystal with a halogen bond of an azopyridine derivative to be converted into isotropic state. In this case, the liquid crystal with a halogen bond of an azopyridine derivative can be uniformly dispersed in the bulk of the sealant, to avoid separating the liquid crystal with a halogen bond of an azopyridine derivative from the bulk of the sealant and reducing the viscosity of the sealant when curing the sealant with UV light. when an isotropic liquid crystal with a halogen bond of an azopyridine derivative is irradiated by visible light, the azo group is transformed from a cis structure to a trans structure, making the liquid crystal with a halogen bond of an azopyridine derivative to be converted from isotropic state to anisotropic state. After the sealant is cured, the liquid crystal with a halogen bond of an azopyridine derivative exhibits anisotropic state under irradiation of visible light and can induce orientation of liquid crystal molecules nearby to avoid light leakage of the liquid crystal display panel.

The liquid crystal with a halogen bond of an azopyridine derivative in this embodiment is of the formula:

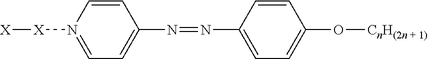

wherein X is a halogen bond.

For example, the liquid crystal with a halogen bond of an azopyridine derivative in an embodiment of the present disclosure can be prepared by the following procedure:

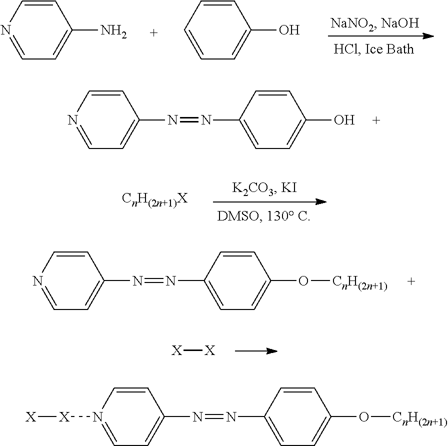

wherein DMSO is dimethyl sulfoxide.

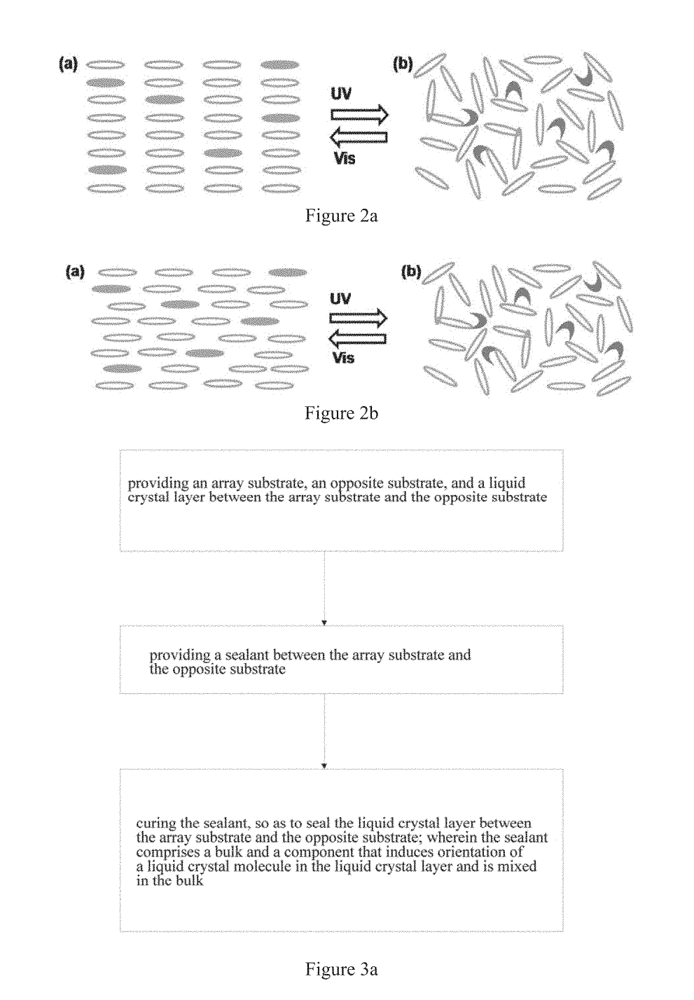

For example, liquid crystals with a halogen bond of an azopyridine derivative can exhibit a smectic or nematic phase. FIGS. 2a and 2b show change in the state of a liquid crystal with a halogen bond of an azopyridine derivative in smectic and nematic phases under irradiation of UV or visible light, respectively. FIG. 2a shows the molecular arrangement of a liquid crystal with a halogen bond of an azopyridine derivative in a smectic phase under irradiation of UV or visible light. FIG. 2b shows the molecular arrangement of a liquid crystal with a halogen bond of an azopyridine derivative in a nematic phase under irradiation of UV or visible light. Referring to FIG. 2a, when the liquid crystal with a halogen bond of an azopyridine derivative in a smectic phase is irradiated under UV light, the azo group is converted from a trans structure to a cis structure, and the liquid crystal with a halogen bond of an azopyridine derivative is converted into isotropic state, thereby being well mixed with the bulk of the sealant and avoiding reduction in the viscosity of the sealant; when the liquid crystal with a halogen bond of an azopyridine derivative in a smectic phase is irradiated under visible light, the azo group is converted from a cis structure to a trans structure, and the liquid crystal with a halogen bond of an azopyridine derivative is converted into anisotropic state and exhibits a smectic phase.

It should be noted that in FIG. 2a, an azo group is shown as grey while other groups in the liquid crystal with a halogen bond of an azopyridine derivative are shown as white. As can be seen from the above description, the change in the azo group under irradiation of ultraviolet light or visible light leads to the change in the state of the liquid crystal with a halogen bond of an azopyridine derivative, and thus the azo group and other groups are shown separately in FIG. 2a. However, the azo group is, in fact, bonded to other groups by chemical bonds.

Referring to FIG. 2b, when the liquid crystal with a halogen bond of an azopyridine derivative in a nematic phase is irradiated under UV light, the azo group is converted from a trans structure to a cis structure, and the liquid crystal with a halogen bond of an azopyridine derivative is converted into isotropic state, thereby being well mixed with the bulk of the sealant and avoiding reduction in the viscosity of the sealant; when the liquid crystal with a halogen bond of an azopyridine derivative in a nematic phase is irradiated under visible light, the azo group is converted from a cis structure to a trans structure, and the liquid crystal with a halogen bond of an azopyridine derivative is converted into anisotropic state and exhibits a nematic phase.

It should be noted that the azo group and other groups in FIG. 2b are shown similar to those in FIG. 2a, i.e., azo group is shown as grey while other groups are shown as white.

As described above, the liquid crystals with a halogen bond of an azopyridine derivative in smectic and nematic phases have similar characteristics under irradiation of ultraviolet light or visible light. That is, the component of the present disclosure which is capable of inducing orientation of liquid crystal molecules may be a liquid crystal with a halogen bond of an azopyridine derivative in a smectic phase, a liquid crystal with a halogen bond of an azopyridine derivative in a nematic phase, or a combination thereof. Whether a liquid crystal with a halogen bond of an azopyridine derivative is in a smectic phase or a nematic phase is mainly dependent on the halogen bond and the n value in —O—CₙH₍₂ₙ₊₁₎. For example, in the case where the halogen bond in the liquid crystal with a halogen bond of an azopyridine derivative is iodine bond, when n is an integer of 7 to 12, the liquid crystal with a halogen bond of an azopyridine derivative exhibits a smectic phase; and when n is an integer of 13 to 24, the liquid crystal with a halogen bond of an azopyridine derivative exhibits a nematic phase. For example, in the case where the halogen bond in the liquid crystal with a halogen bond of an azopyridine derivative is bromine bond, when n is an integer of 7 to 24, the liquid crystal with a halogen bond of an azopyridine derivative exhibits a smectic phase.

In one embodiment, the halogen bond in the liquid crystal with a halogen bond of an azopyridine derivative (X in the above formula of the liquid crystal with a halogen bond of an azopyridine derivative) is at least one of an iodine bond and a bromine bond. In this case, the effect of inducing orientation of liquid crystal molecules is superior.

In one embodiment, the group chemically bonded to the azopyridine group in the liquid crystal with a halogen bond of an azopyridine derivative (referring to the above formula) comprises —O—CₙH₍₂ₙ₊₁₎, where the value of n affects the compatibility of the liquid crystal with a halogen bond of an azopyridine derivative with the bulk of the sealant and the ability to orient the liquid crystal molecules. For example, in one embodiment, the value of n in the —O—CₙH₍₂ₙ₊₁₎ group is ranged from 7 to 24. But the range of n is not limited to this.

It should be noted that the above liquid crystal with a halogen bond of an azopyridine derivative may include components having different n values at the same time. That is, the above liquid crystal with a halogen bond of an azopyridine derivative may be a mixture comprising components having different n values. For example, the above liquid crystal with a halogen bond of an azopyridine derivative may include a component having a smaller n value (e.g., 7 to 10), a component having a mediate n value (e.g., 14 to 17), and a component having a larger n value (e.g., 21 to 24) at the same time.

Depending on the bulk of the sealant, the mass content of the liquid crystal with a halogen bond of an azopyridine derivative in the sealant may vary. If the curing ratio of the bulk of the sealant used is relatively low, more small molecule monomers which are not cured and polymerized will enter the liquid crystal layer, which requires the addition of more liquid crystals with a halogen bond of an azopyridine derivative; however, since the curing ratio of the bulk of the sealant itself is low, if the addition of an uncured liquid crystals with a halogen bond of an azopyridine derivative is too much, the cure ratio of the sealant will be further reduced, thereby affecting the curing effect. If the curing ratio of the bulk of the sealant used is relatively high, small molecules which are not cured and polymerized will be less, and better technical effect can be achieved by adding a small amount of liquid crystals with a halogen bond of an azopyridine derivative. The appropriate amount of addition need be selected according to both the effect of the liquid crystal with a halogen bond of an azopyridine derivative on the curing result and the action of the liquid crystal with a halogen bond of an azopyridine derivative for orienting liquid crystal molecules. For example, in one embodiment, the mass content of the liquid crystal with a halogen bond of an azopyridine derivative in the sealant is about 1-10%.

In one embodiment, the bulk comprises an ultraviolet curable component. As described above, the liquid crystal with a halogen bond of an azopyridine derivative can exhibit isotropic under irradiation of ultraviolet light, and thus is well compatible with the bulk of the sealant. Therefore, in the case where the ultraviolet curable component is contained in the bulk, the liquid crystal with a halogen bond of an azopyridine derivative will be well dissolved in the bulk of the sealant during the ultraviolet curing.

In one embodiment, the bulk further comprises a thermally curable component. In this case, for example, the sealant can be further cured by thermal curing to increase the cure ratio of the sealant. For example, the thermal curing may be carried out before or after UV curing.

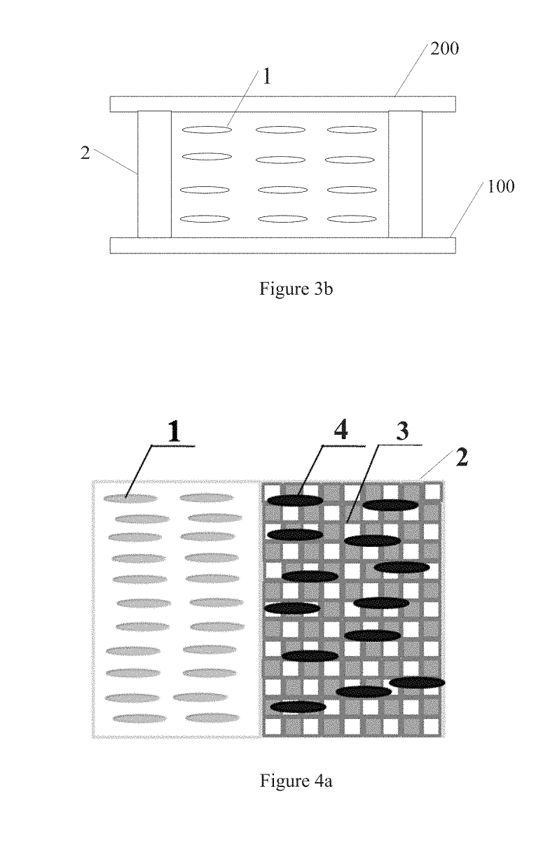

Another aspect of an embodiment of the present disclosure provides a method for manufacturing a liquid crystal display panel. For example, referring to FIGS. 3a and 3b, the method comprises:

providing an array substrate 100, an opposite substrate 200 and a liquid crystal layer between the array substrate 100 and the opposite substrate 200;
providing a sealant 2 between the array substrate 100 and the opposite substrate 200; and
curing the sealant 2 to seal the liquid crystal layer between the array substrate 100 and the opposite substrate 200; wherein the sealant 2 comprises a bulk and a component that induces orientation of a liquid crystal molecule and is mixed in the bulk.

In one embodiment, the component that induces orientation of a liquid crystal molecule is isotropic under irradiation of ultraviolet light and is anisotropic under irradiation of visible light. The bulk of the sealant typically comprises an ultraviolet curable component to cure the sealant under irradiation of ultraviolet light. In the case where the sealant is irradiated by ultraviolet light, the component that induces orientation of a liquid crystal molecule is, for example, isotropic so as to be better mixed with the bulk of the sealant to avoid reducing the viscosity of the sealant, and at the same time, avoid separating the component inducing orientation of a liquid crystal molecule from the bulk during the UV curing process and affecting the curing effect. In addition, the component that induces orientation of a liquid crystal molecule need to be able to induce orientation of the liquid crystal molecule. As described above, the component that induces orientation of a liquid crystal molecule is, for example, oriented in a specific direction by itself, thereby inducing the liquid crystal molecules to be also oriented in the specific direction. Thus, after UV curing of the sealant, the component that induces orientation of a liquid crystal molecule need to be oriented in a specific direction, i.e., need to be changed from isotropic state to anisotropic state. For example, the component that induces orientation of a liquid crystal molecule can be changed to anisotropic state under irradiation of visible light.

For example, the component that induces orientation of a liquid crystal molecule is also isotropic before the sealant is cured, so that the component that induces orientation of a liquid crystal molecule can be easily mixed in the bulk of the sealant during preparing the sealant.

In one embodiment, the component that induces orientation of a liquid crystal molecule is a liquid crystal with a halogen bond of an azopyridine derivative.

In one embodiment, the halogen bond in the liquid crystal with a halogen bond of an azopyridine derivative is at least one of an iodine bond and a bromine bond. For example, the halogen bond in the liquid crystal with a halogen bond of an azopyridine derivative may be a bromine bond, or an iodine bond, or may be a bromine bond and an iodine bond.

In one embodiment, the group chemically bonded to the azopyridine group in the liquid crystal with a halogen bond of an azopyridine derivative comprises —O—CₙH₍₂ₙ₊₁₎, where the value of n affects the compatibility of the liquid crystal with a halogen bond of an azopyridine derivative with the bulk of the sealant and the ability to orient the liquid crystal molecules. In one embodiment, the value of n in the —O—CₙH₍₂ₙ₊₁₎ group is ranged from 7 to 24.

It should be noted that the above liquid crystal with a halogen bond of an azopyridine derivative may include components having different n values at the same time. That is, the above liquid crystal with a halogen bond of an azopyridine derivative may be a mixture comprising components having different n values. For example, the above liquid crystal with a halogen bond of an azopyridine derivative may include a component having a smaller n value (e.g., 7 to 10), a component having a mediate n value (e.g., 14 to 17), and a component having a larger n value (e.g., 21 to 24) at the same time.

In one embodiment, the mass content of the liquid crystal with a halogen bond of an azopyridine derivative in the sealant is about 1-10%.

In one embodiment, curing the sealant comprises: irradiating the sealant under ultraviolet light; and in the case where the sealant is irradiated under ultraviolet light, the liquid crystal with a halogen bond of an azopyridine derivative is converted into isotropic state. For example, the ultraviolet light used has an intensity of about 500 to 2000 mW/cm², and the duration for irradiating the liquid crystal display panel is about 5 to 60 s.

In one embodiment, curing the sealant further comprises thermal curing of the sealant. In this way, the sealant can be more fully cured. For example, in the case of thermal curing, the heating temperature is about 80° C. to 140° C. and the heating duration is about 40 min to 90 min.

In one embodiment, the method further comprises: after curing the sealant, the sealant is irradiated under visible light to cause the liquid crystal with a halogen bond of an azopyridine derivative to be converted into anisotropic state.

Hereinafter, a method of manufacturing a liquid crystal display panel according to an embodiment of the present disclosure will be described in detail with reference to examples.

### Example 1

a) A liquid crystal with a halogen bond of an azopyridine derivative (wherein n=12 and X=I) and a commercially available sealant SWB-73 were homogeneously mixed at a mass ratio of 5:95, and the liquid crystal with a halogen bond of an azopyridine derivative exhibited a smectic phase;
b) A circle of the mixture in (a) was applied at a width of 0.5 mm at the sealant area of an array substrate and/or an opposite substrate;
c) The opposite substrate and the array substrate with liquid crystals were cell-assembled in vacuum;
d) The liquid crystal display panel in (c) was irradiated under ultraviolet light of 500 mW/cm² for 20 seconds, and at this time the liquid crystal with a halogen bond of an azopyridine derivative in the sealant was converted into isotropic state;
e) The liquid crystal display panel in (d) was heated at 130° C. for 50 min;
f) The liquid crystal display panel in (e) was irradiated under visible light, and at this time the liquid crystal with a halogen bond of an azopyridine derivative in the sealant was converted into a smectic phase to induce orientation of liquid crystal molecules near the sealant in the liquid crystal display panel, thereby preventing the liquid crystal molecules from being disturbed in orientation.

### Example 2

a) A liquid crystal with a halogen bond of an azopyridine derivative (wherein n=15 and X=I) and a commercially available sealant SWB-73 were homogeneously mixed at a mass ratio of 3:97, and the liquid crystal with a halogen bond of an azopyridine derivative exhibited a nematic phase;
b) A circle of the mixture in (a) was applied at a width of 0.6 mm at the sealant area of an array substrate and/or an opposite substrate;
c) The opposite substrate and the array substrate with liquid crystals were cell-assembled in vacuum;
d) The liquid crystal display panel in (c) was irradiated under ultraviolet light of 1000 mW/cm² for 8 seconds, and at this time the liquid crystal with a halogen bond of an azopyridine derivative in the sealant was converted into isotropic state;
e) The liquid crystal display panel in (d) was heated at 120° C. for 60 min;
f) The liquid crystal display panel in (e) was irradiated under visible light, and at this time the liquid crystal with a halogen bond of an azopyridine derivative in the sealant was converted into a nematic phase to induce orientation of liquid crystal molecules near the sealant in the liquid crystal display panel, thereby preventing the liquid crystal molecules from being disturbed in orientation. When applied to a liquid crystal display device, the liquid crystal display panel prepared can prevent the liquid crystal display device from light-leakage.

### Example 3

(a) A liquid crystal with a halogen bond of an azopyridine derivative (wherein n=10 and X=Br) and a commercially available sealant SWB-73 were homogeneously mixed at a mass ratio of 6:94, and the liquid crystal with a halogen bond of an azopyridine derivative exhibited a smectic phase;
(b) A circle of the mixture in (a) was applied at a width of 0.45 mm at the sealant area of an array substrate and/or an opposite substrate;
(c) The opposite substrate and the array substrate with liquid crystals were cell-assembled in vacuum;
(d) The liquid crystal display panel in (c) was irradiated under ultraviolet light of 1500 mW/cm² for 5 seconds, and at this time the liquid crystal with a halogen bond of an azopyridine derivative in the sealant was converted into isotropic state;
(e) The liquid crystal display panel in (d) was heated at 100° C. for 75 min;
(f) The liquid crystal display panel in (e) was irradiated under visible light, and at this time the liquid crystal with a halogen bond of an azopyridine derivative in the sealant was converted into a smectic phase to induce orientation of liquid crystal molecules near the sealant in the liquid crystal display panel, thereby preventing the liquid crystal molecules from being disturbed in orientation.

The “n” and “X” in the above three examples correspond to “n” and “X” in the above formula of a liquid crystal with a halogen bond of an azopyridine derivative.

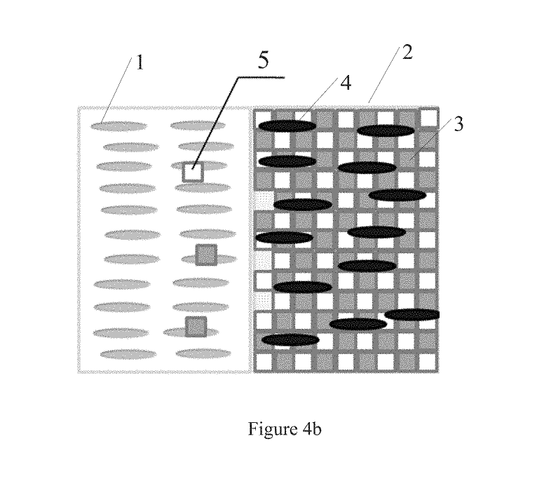

FIGS. 4a and 4b are schematic views showing the effect of the sealant according to embodiments of the present disclosure. FIG. 4a is a schematic view of arrangement of liquid crystal molecules in the case where small molecules that are not cured and polymerized in the sealant do not enter the liquid crystal layer; FIG. 4b is a schematic view of arrangement of liquid crystal molecules in the case where small molecules that are not cured and polymerized in the sealant enter the liquid crystal layer. Referring to FIGS. 4a and 4b, the liquid crystal display panel includes a liquid crystal layer (only a portion of the liquid crystal layer is shown in the Figures) provided in a display region and a sealant 2 provided in a non-display region. The sealant 2 comprises a bulk 3 and a component 4 that induces orientation of a liquid crystal molecule.

As shown in FIG. 4a, the liquid crystal molecules 1 in the liquid crystal layer can be normally oriented in the case where the small molecules which are not cured and polymerized in the sealant do not enter the liquid crystal layer. As shown in FIG. 4b, in the case where the small molecules 5 which are not cured and polymerized in the sealant 2 enters the liquid crystal layer, the liquid crystal molecules 1 in the liquid crystal layer can still be normally oriented due to the presence of the component 4 inducing orientation of a liquid crystal molecule, thereby avoiding influence of the small molecules on orientation of the liquid crystal molecules, and preventing light leakage of the liquid crystal display panel.

Still another aspect of the present disclosure provides a liquid crystal display panel including the above-described sealant.

In the present disclosure, words such as “first”, “second” and the like do not request or denote any relationship or order between entities or operations, but rather are used for distinguishing one entity or operation from another entity or operation. Words such as “include” and “comprise” are open-ended expressions, not exclusive of the case that the included processes, methods and objects further have other elements. It further should be noted that words such as “up”, “down” and the like denote direction or position relationships based on the accompanying drawings, and are only used for facilitating describing the present disclosure and simplifying description, rather than indicate or denote that the indicated apparatus or elements shall have specific directions and be constructed and operated in specific directions, and thus, it should not be understood as limitation to the present disclosure. Unless otherwise defined, words such as “installing”, “connected” and “connecting” should be understood in general, for example, can be fixed connection, also can be detachable connection, or integrated connection, can be mechanical connection, also can be electrical connection, can be direct connection, also can be indirect connection by an intermediate medium, and also can be communication inside two elements. Those ordinarily skilled in the art can understand the specific meaning of the words in the present disclosure according to the particular case.

The foregoing embodiments merely are exemplary embodiments of the disclosure, and not intended to define the scope of the disclosure, and the scope of the disclosure is determined by the appended claims.

The present application claims the priority of the Chinese Patent Application No. 201610683011.3 filed on Aug. 17, 2016, which is incorporated herein by reference as part of the disclosure of the present application.

1. A sealant, which comprises
a bulk and
a component that induces orientation of a liquid crystal molecule and is mixed in the bulk.

2. The sealant of claim 1, wherein the component inducing orientation of a liquid crystal molecule is isotropic under irradiation of ultraviolet light and is anisotropic under irradiation of visible light.

3. The sealant of claim 1, wherein the component inducing orientation of a liquid crystal molecule is a liquid crystal with a halogen bond of an azopyridine derivative.

4. The sealant of claim 3, wherein the halogen bond in the liquid crystal with a halogen bond of an azopyridine derivative is at least one of an iodine bond and a bromine bond.

5. The sealant of claim 3, wherein a group chemically bonded to the azopyridine group in the liquid crystal with a halogen bond of an azopyridine derivative comprises —O—CₙH₍₂ₙ₊₁₎.

6. The sealant of claim 5, wherein n in the —O—CₙH₍₂ₙ₊₁₎ group is in the range of 7 to 24.

7. The sealant of claim 3, wherein the liquid crystal with a halogen bond of an azopyridine derivative has a mass content of about 1 to 10% in the sealant.

8. The sealant of claim 1, wherein the bulk comprises an ultraviolet curable component.

9. The sealant of claim 8, wherein the bulk further comprises a thermally curable component.

10. A method for manufacturing a liquid crystal display panel, which comprises:
providing an array substrate, an opposite substrate, and a liquid crystal layer between the array substrate and the opposite substrate;
providing a sealant between the array substrate and the opposite substrate; and
curing the sealant, so as to seal the liquid crystal layer between the array substrate and the opposite substrate;
wherein the sealant comprises a bulk and a component that induces orientation of a liquid crystal molecule in the liquid crystal layer and is mixed in the bulk.

11. The method of claim 10, wherein curing the sealant comprises irradiating the sealant under ultraviolet light; and the liquid crystal with a halogen bond of an azopyridine derivative is converted to isotropic state upon irradiating the sealant under ultraviolet light.

12. The method of claim 11, wherein curing the sealant further comprises thermal curing of the sealant.

13. The method of claim 10, further comprising:
irradiating the sealant under visible light after curing the sealant, so as to convert the liquid crystal with a halogen bond of an azopyridine derivative to anisotropic state.

14. A liquid crystal display panel, which comprises:
an array substrate,
an opposite substrate,
a liquid crystal layer between the array substrate and the opposite substrate, and
the sealant of claim 1,
wherein the sealant is between the array substrate and the opposite substrate and seals the liquid crystal layer between the array substrate and the opposite substrate.

15. The sealant of claim 2, wherein the component inducing orientation of a liquid crystal molecule is a liquid crystal with a halogen bond of an azopyridine derivative.

16. The sealant of claim 5, wherein the liquid crystal with a halogen bond of an azopyridine derivative is of the formula: 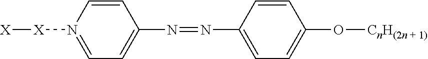
wherein X is a halogen bond.

17. The method of claim 11, further comprising:
irradiating the sealant under visible light after curing the sealant, so as to convert the liquid crystal with a halogen bond of an azopyridine derivative to anisotropic state.

18. The method of claim 12, further comprising:
irradiating the sealant under visible light after curing the sealant, so as to convert the liquid crystal with a halogen bond of an azopyridine derivative to anisotropic state.

19. A liquid crystal display panel, which comprises:
an array substrate,
an opposite substrate,
a liquid crystal layer between the array substrate and the opposite substrate, and
the sealant of claim 2,
wherein the sealant is between the array substrate and the opposite substrate and seals the liquid crystal layer between the array substrate and the opposite substrate.

20. A liquid crystal display panel, which comprises:
an array substrate,
an opposite substrate,
a liquid crystal layer between the array substrate and the opposite substrate, and
the sealant of claim 3,
wherein the sealant is between the array substrate and the opposite substrate and seals the liquid crystal layer between the array substrate and the opposite substrate.
